(19) United States
(12) Patent Application Publication
(10) Pub. No.: US 2021/0008849 A1
(43) Pub. Date: Jan. 14, 2021

(54) Multilayer composite material

(71) Applicant: LANXESS Deutschland GmbH, Cologne (DE)

(72) Inventors: Martin Wanders, Odenthal-Neschen (DE); Stefan Seidel, Paderborn (DE); Lukas Schroer, Essen (DE)

(73) Assignee: LANXESS Deutschland GmbH, Cologne (DE)

(21) Appl. No.: 16/923,431

(22) Filed: Jul. 8, 2020

(30) Foreign Application Priority Data
Jul. 9, 2019 (EP) 19185155.9

(51) Int. Cl. B32B 27/08; B32B 5/02; B32B 27/36; B32B 7/03

(52) U.S. Cl. CPC B32B 27/08; B32B 5/024; B32B 27/365; B32B 7/03; B32B 2457/00; B32B 2305/188; B32B 2260/023; B32B 2262/101; B32B 2250/244; B32B 2262/106

(57) ABSTRACT

The present invention relates to a multilayer composite material, to a process for the production thereof and to a housing part or a housing of an electronic device comprising such a multilayer composite material.

The present invention relates to a multilayer composite material based on at least one thermoplastic from the group consisting of polycarbonates, polybutylene terephthalates, styrene-acrylonitriles, polystyrenes, polyether ether ketones, polyetherimides, polysulfones, thermoplastic elastomers, polyphenylene sulfides and mixtures thereof, in particular polycarbonate, to a process for the production thereof and to a housing part or a housing of an electronic device comprising such a multilayer composite material.

### PRIOR ART

Numerous fibre composite materials and processes for the production thereof are known from the prior art. WO2013/098224A1 describes a process for producing a fibre composite material in the form of a plastic-impregnated wide fibre tape and a multilayer composite structure obtainable from sections of the wide fibre tape. Both thermosetting plastics and thermoplastics may be used as the plastic matrix.

DE102012200059A1 describes a fibre-reinforced multilayer composite material having a thermoplastic plastic matrix. However, the multilayer composite materials known from the prior art are greatly in need of improvement in terms of their optical, sonic, haptic and mechanical properties if the intention is to approximate the properties of housings made of metal alloys.

In recent years the trend in the field of portable electronic devices in particular, especially mobile telephones, laptops or tablets in the context of the present invention, has been for ever lighter and thinner devices. This demands inter alia the development of extremely light and thin housings which at the same time exhibit a high mechanical stability to protect the screen and electronics of the instrument. Magnesium-aluminium alloys for example have now become established as prior art for such purposes. The advantage of housings made of such metal alloys are their light weight and their high mechanical stability. Furthermore, such metal housings are also considered aesthetically appealing and high quality by the consumer. By contrast, housings made of conventional plastic are regarded as rather low quality by the consumer and cannot compete with the metal alloys in terms of the mechanical properties either. However, the latter have the considerable disadvantage that they must be produced from costly raw materials in complex and energy-intensive processes and this is associated with high production costs. In terms of resource conservation too it is therefore desirable to develop equivalent quality replacement materials for the metal alloys used in the prior art.

One attempt is provided by WO 2017/072053 A1 in which multilayered fibre composite materials for this purpose are described. However, the multilayered fibre composite materials described in WO 2017/072053 A1 are based exclusively on unidirectionally oriented reinforcing fibres. In each layer the fibre materials incorporated in the multilayered fibre composite materials according to WO 2017/072053 A1 have only one orientation and thus result in markedly anisotropic mechanical properties. As a result the multilayered fibre composite materials according to WO 2017/072053 A1 differ very markedly from the properties of metallic materials in terms of optical, haptic, sonic and mechanical properties.

The plastic matrix materials used for fibre composite materials in the prior art are especially thermally curable thermosetting plastics (thermosets), such as urea-formaldehyde resins or epoxy resins, or thermoplastics, such as polyamides, polypropylene or polyethylene. Many thermoplastics of industrial importance, in particular polycarbonates, have the disadvantage of high usage temperatures, high transparencies, high stiffnesses and more, and compared to typically employed thermoplastics have the disadvantage that they tend not to creep and thus have a propensity for cracking under constant stress. This is highly problematic especially for use in fibre composite materials containing endless fibres. This is because fibre composite materials containing endless fibres in their plastic matrix are under constant stress as a result of the endless fibres. As a result, thermoplastics having similar properties to polycarbonates have in practice played hitherto only a minor role as a plastic matrix for such fibre composite materials containing endless fibres. However in principle it would be desirable to expand the field of use of thermoplastics, in particular polycarbonates, to also include composite materials since compared to the other customary thermoplastics, such as polyamide or polypropylene, polycarbonates exhibit a lower volume shrinkage during hardening. Polycarbonates further exhibit higher heat resistances.

Against this backdrop there remains a requirement to develop alternative lightweight materials to the above-described metal alloys which exhibit similar optical, haptic, sonic and mechanical properties to the housings based on metal alloys but are more cost-effective to produce.

Starting from the prior art the problem addressed by the present invention was that of providing a novel material that exhibits a metallic appearance, metallic sound, metallic haptics and metal-like mechanical properties and is more suitable as a housing part material for a housing of an electronic device than the materials of WO 2017/072053 A1. To this end the material should moreover be lightweight, cost-effective to produce and have a very smooth and thus optically appealing surface.

It has been found that, surprisingly, a multilayer composite material having particularly pronounced metallic haptics and optics and virtually metallic, i.e. isotropic, mechanical characteristics is obtained when at least three fibre composite material plies defined relative to one another as two outer fibre composite material plies and at least one inner fibre composite material ply are superposed, wherein each of these at least three fibre composite material plies contains endless fibres in the form of a textile semifinished product and the endless fibres in the respective fibre composite material ply have any desired orientation and are embedded in thermoplastic, with the proviso that in the case of only one inner fibre composite material ply this is rotated by 0° to 90° with respect to the outer fibre composite material plies or in the case of two or more inner fibre composite material plies these inner fibre composite material plies have a substantially identical orientation and their orientation with respect to the outer fibre composite material plies is rotated by 0° to 90° and the orientation of a fibre composite material ply is defined by the orientation of the textile semifinished product containing the endless fibres.

### SUBJECT MATTER OF THE INVENTION

The subject matter of the present invention and solution to the problem is a

multilayer composite material comprising two outer fibre composite material plies (3) and at least one inner fibre composite material ply (2), wherein each of these at least three fibre composite material plies (2) and (3) contains endless fibres (4) in the form of a textile semifinished product, preferably in the form of a balanced woven fabric, a nonwoven fabric or a fibre mat, wherein the endless fibres (4) in the respective fibre composite material ply (2) or (3) have any desired orientation and are embedded in at least one thermoplastic (5),

with the proviso that
a) the at least one inner fibre composite material ply (2) is rotated by 0° to 90° with respect to the outer fibre composite material plies (3),
b) for ≥2 inner fibre composite material plies (2) these inner fibre composite material plies have a substantially identical orientation and their orientation with respect to the outer fibre composite material plies (3) is rotated by 0° to 90°,
   and the orientation of a fibre composite material ply (2) or (3) is defined by the orientation of the textile semifinished product containing the endless fibres, the thermoplastic employed is at least one from the group consisting of polycarbonates, polybutylene terephthalates, styrene-acrylonitriles, polystyrenes, polyether ether ketones, polyetherimides, polysulfones, thermoplastic elastomers, polyphenylene sulfides and mixtures thereof, in particular polycarbonate, and having any desired orientation is to be understood as meaning a divergence of the main directions of the endless fibres in a fibre composite material ply from the production direction of the employed textile semifinished product in the plane in the range from >0° to <90°. The multilayer composite materials according to the invention have the advantage that they are cost-effective to produce and exhibit a virtually isotropic stiffness. The multilayer composite materials according to the invention further feature good paintability and film-insert mouldability when the thermoplastic selected is itself a plastic that features good paintability or film-insert mouldability.

A further advantage of the multilayer composite materials according to the invention is that the shaping thereof, in particular into the form of a housing part, may be carried out in a particularly simple and flexible fashion as a result of the thermoformability of the multilayer composite material itself and this processing step makes it possible to establish very nearly any desired surface qualities.

Practical experiments in the context of the present invention have shown that under two-dimensional flexural stress, especially when using endless fibres in the form of textile semifinished products having no prevailing fibre orientation, the multilayer composite materials according to the invention exhibit very largely identical properties in the 3- or 4-point bending test for any of the fibre orientations present. In particular, for two orientations which preferably differ by an angle of 90°, the flexural strength only differed by less than 5%!

The invention further provides a process for producing a multilayer composite material according to the invention comprising the following steps of:
providing at least one inner fibre composite material ply (2) and two outer fibre composite material plies (3),
placing the at least one inner fibre composite material ply (2) between the outer fibre composite material plies (3),
joining the layered fibre composite material plies (2) and (3), especially using pressure and temperature, to afford the multilayer composite material (1),
   with the proviso that each of these at least three fibre composite material plies (2) and (3) contains endless fibres (4) in the form of a textile semifinished product, preferably in the form of a balanced woven fabric, a nonwoven fabric or a fibre mat, wherein the endless fibres (4) in the respective fibre composite material ply (2) or (3) have any desired orientation and are embedded in at least one thermoplastic (5), and

a) the at least one inner fibre composite material ply (2) is rotated by 0° to 90° with respect to the outer fibre composite material plies (3),

b) for inner fibre composite material plies (2) these inner fibre composite material plies have a substantially identical orientation and their orientation with respect to the outer fibre composite material plies (3) is rotated by 0° to 90°,

and the orientation of a fibre composite material ply (2) or (3) is defined by the orientation of the textile semifinished product containing the endless fibres, the thermoplastic employed is at least one from the group consisting of polycarbonates, polybutylene terephthalates, styrene-acrylonitriles, polystyrenes, polyether ether ketones, polyetherimides, polysulfones, thermoplastic elastomers, polyphenylene sulfides and mixtures thereof, in particular polycarbonate, and having any desired orientation is to be understood as meaning a divergence of the main directions of the endless fibres in a fibre composite material ply from the production direction of the employed textile semifinished product in the plane in the range from >0° to <90°. The invention further provides a process for producing a housing or housing part according to the invention comprising at least one multilayer composite material according to the invention.

The invention further provides the use of at least one multilayer composite material comprising two outer fibre composite material plies (3) and at least one inner fibre composite material ply (2), wherein each of these at least three fibre composite material plies (2) and (3) contains endless fibres (4) in the form of a textile semifinished product, preferably in the form of a balanced woven fabric, a nonwoven fabric or a fibre mat, wherein the endless fibres (4) in the respective fibre composite material ply (2) or (3) have any desired orientation and are embedded in at least one thermoplastic (5), for producing housings, preferably housings for electrical or electronic devices,

with the proviso that

a) the at least one inner fibre composite material ply (2) is rotated by 0° to 90° with respect to the outer fibre composite material plies (3),

b) for inner fibre composite material plies (2) these inner fibre composite material plies have a substantially identical orientation and their orientation with respect to the outer fibre composite material plies (3) is rotated by 0° to 90°,

and the orientation of a fibre composite material ply (2) or (3) is defined by the orientation of the textile semifinished product containing the endless fibres, the thermoplastic employed is at least one from the group consisting of polycarbonates, polybutylene terephthalates, styrene-acrylonitriles, polystyrenes, polyether ether ketones, polyetherimides, polysulfones, thermoplastic elastomers, polyphenylene sulfides and mixtures thereof, in particular polycarbonate, and any desired orientation is to be understood as meaning a divergence of the main directions of the endless fibres in a fibre composite material ply from the production direction of the employed textile semifinished product in the plane in the range from >0° to <90°.

The invention finally provides articles, preferably housings, particularly preferably housings for electrical or electronic devices, comprising at least one multilayer composite material according to the invention.

In the context of the invention the term endless fibre is to be understood as a delineation from the short or long fibres likewise known to those skilled in the art. Endless fibres generally extend over the entire length of a fibre composite material ply. The present invention refers to DIN 60001 according to which fibres having a length of at least 1000 mm, i.e. one metre, are referred to as endless fibres.

Especially after processing and cutting to size the produced articles may have dimensions smaller than 1 m and thus may well have fibre lengths of less than one metre which are nevertheless referred to as endless fibres in the context of the invention. In respect of the term endless fibre (filament) reference is also made to:

https://de.wikipedia.org/wiki/Faser-Kunststoff-Verbund

In the context of the invention the term textile semifinished product or textile refers to a textile product manufactured with customary production processes, in particular weaving, in which the described endless fibres are used as a starting material. In the context of the invention the endless fibres are therefore present over the entire textile length and over the entire textile width. Impregnation with the plastic matrix changes nothing about the length and position of the endless fibres, so that also in the case of reinforcement by a textile semifinished product or textile the endless fibres extend over the entire length/the entire width of the fibre composite material. A textile may also consist of staple fibres or random-laid fibre mats in which the individual endless fibres do not extend over the entire width of a fibre composite material and thus of a multilayer composite material according to the invention but are individually markedly longer than fibres typically described as “long fibres” and additionally, by interlocking, form a yarn or a mat which in turn extend over the entire width of a fibre composite plastic and thus of a multilayer composite plastic according to the invention and are accordingly also classified as endless fibres in the context of the invention.

A textile semifinished product in the context of the present invention is also understood as meaning an endless fibre tape, wherein said tape comprises a plurality of combined rovings and wherein the rovings are bundles of many endless fibres in an untwisted state.

Quasi-isotropic stiffness in the context of the invention means that the flexural strengths of the fibre composite material in the main directions 0° and 90° in the plane of the fibre composite material differ from one another by less than 5%.

For the sake of clarity it is noted that the scope of the present invention comprises all of the definitions and parameters recited below in general or in preferred ranges in any desired combinations. This likewise applies to combinations of individual chemical components with all physical parameters recited in the present application. The standards cited in the context of this application refer to the version current at the filing date of the present invention.

### PREFERRED EMBODIMENTS OF THE INVENTION

In order to improve the optics and smoothness of the surface of a multilayer composite material according to the invention it has proven advantageous when this multilayer composite material preferably has a thickness ratio of the sum of the two outer fibre composite material plies to the sum of all inner fibre composite material plies in the range from 0.25 to 5, particularly preferably a thickness ratio in the range from 0.8 to 3, very particularly preferably a thickness ratio in the range from 1 to 2.5.

The endless fibres are preferably present in a fibre composite material according to the invention in the form of a textile semifinished product from the group of balanced woven fabrics, nonwoven fabrics and fibre mats, wherein the endless fibres in the respective fibre composite material ply have any desired alignment. Fibre composite materials in the form of a textile semifinished product in which the endless fibres are present in the form of a balanced woven fabric and in which the endless fibres have any desired alignment are especially preferred.

Woven fabrics are textile fabrics consisting of two thread systems, warp (warp threads) and weft (weft threads) which cross in a pattern at an angle of precisely or approximately 90° in a plan view of the fabric surface. The warp threads run in the longitudinal direction of the fabric, parallel to the selvedge, and the weft threads run in the transverse direction, parallel to the crosswise edge. The production of fabrics is carried out either by hand weaving on a hand loom or mechanically on a power loom. The manner of crossing of the warp and weft threads in a fabric is referred to as the weave. A different distribution of picks and thus a different fabric weave, which determines product appearance, are formed according to which warp threads are raised and lowered during weaving. The part of the weave that indicates the manner of crossing of the warp and weft threads until their repetition is referred to as the rapport. The fundamental weaves of woven fabrics are linen weave, twill weave or satin weave, twill weave being preferred according to the invention. In the context of the invention a fabric is considered balanced when the number of warp threads and weft threads is identical over a defined length and warp threads and weft threads have an identical yarn linear density.

The individual fibre composite material plies to be employed according to the invention are preferably obtainable by applying molten polycarbonate-based plastic to a textile semifinished product, also referred to as raw textile, preheated to above the glass transition temperature of the plastic to be employed.

The fibre volume content of the outer fibre composite material plies is preferably at most 60% by volume based on the volume of the outer fibre composite material plies.

The plastic is preferably selected from the group consisting of polycarbonates, polybutylene terephthalates, styrene-acrylonitriles, polystyrenes, polyether ether ketones, polyetherimides, polysulfones, thermoplastic elastomers, polyphenylene sulfides and mixtures thereof. Thermoplastic polyurethane and polycarbonate are particularly preferred. Polycarbonate is especially preferred.

Polycarbonate

A polycarbonate-based plastic in the context of the present invention is to be understood as meaning a plastic containing at least 50% by weight, by preference at least 60% by weight, preferably at least 70% by weight, in particular at least 80% by weight, particularly preferably at least 90% by weight, very particularly preferably at least 95% by weight, in particular at least 97% by weight, of polycarbonate. In other words in the context of the present invention a polycarbonate-based plastic may contain at most 50% by weight, by preference at most 40% by weight, preferably at most 30% by weight, in particular at most 20% by weight, particularly preferably at most 10% by weight, very particularly preferably at most 5% by weight, in particular at most 3% by weight, of one or more plastics distinct from polycarbonate as blend partners.

It is preferable when the polycarbonate-based plastic contains 100% by weight of polycarbonate.

In the context of the present invention the term polycarbonate also comprises mixtures of different polycarbonates. Furthermore, polycarbonate is here used as an umbrella term and thus comprises both homopolycarbonates and copolycarbonates. The polycarbonates may moreover be linear or branched in known fashion.

In a particular embodiment of the invention the polycarbonate-based plastic consists substantially, particularly preferably to an extent of 70% by weight, very particularly preferably to an extent of 80% by weight, especially preferably to an extent of 90% by weight, especially particularly preferably to an extent of 100% by weight, of a linear polycarbonate.

The polycarbonates may be produced in known fashion from diphenols, carbonic acid derivatives and optionally chain terminators and branching agents. Particulars pertaining to the production of polycarbonates have been well known to a person skilled in the art for at least about 40 years. Reference may be made here for example to Schnell, Chemistry and Physics of Polycarbonates, Polymer Reviews, Volume 9, Interscience Publishers, New York, London, Sydney 1964, to D. Freitag, U. Grigo, P. R. Müller, H. Nouvertne, BAYER AG, Polycarbonates in Encyclopedia of Polymer Science and Engineering, Volume 11, Second Edition, 1988, pages 648-718, and finally to U. Grigo, K. Kirchner and P. R. Müller Polycarbonate in BeckerBraun, Kunststoff-Handbuch, Volume 31, Polycarbonate, Polyacetale, Polyester, Celluloseester, Carl Hanser Verlag Munich, Vienna 1992, pages 117-299.

Aromatic polycarbonates which are preferred to be used according to the invention are produced on the one hand by reaction of diphenols with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Production via a melt polymerization process by reaction of diphenols with diphenyl carbonate for example is on the other hand possible. Diphenols suitable for producing polycarbonates which are to be used according to the invention are preferably hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from isatin derivatives or from phenolphthalein derivatives and also their ring-alkylated, ring-arylated and ring-halogenated compounds.

Preferably employed reactants are diphenols based on phthalimides, in particular 2-aralkyl-3,3′-bis(4-hydroxyphenyl)phthalimides or 2-aryl-3,3′-bis(4-hydroxyphenyl)phthalimides, in particular 2-phenyl-3,3′-bis(4-hydroxyphenyl)phthalimide, 2-alkyl-3,3′-bis(4-hydroxyphenyl)phthalimides, in particular 2-butyl-3,3′-bis(4-hydroxyphenyl)phthalimides, 2-propyl-3,3′-bis(4-hydroxyphenyl)phthalimides, 2-ethyl-3,3′-bis(4-hydroxyphenyl)phthalimides or 2-methyl-3,3′-bis(4-hydroxyphenyl)phthalimides, and also diphenols based on isatins substituted at the nitrogen, in particular 3,3-bis(4-hydroxyphenyl)-1-phenyl-1H-indol-2-one or 2,2-bis(4-hydroxyphenyl)-1-phenyl-1H-indol-3-one.

Preferred diphenols are

4,4′-dihydroxydiphenyl [CAS No. 92-88-6],

2,2-bis(4-hydroxyphenyl)propane (bisphenol A) [CAS No. 80-05-7],

2,4-bis(4-hydroxyphenyl)-2-methylbutane,

alpha,alpha′-bis(4-hydroxyphenyl)-p-diisopropylbenzene,

2,2-bis(3-methyl-4-hydroxyphenyl)propane,

dimethylbisphenol A [CAS No. CAS 1568-83-8],

bis(3,5-dimethyl-4-hydroxyphenyl)methane,

2,2-bis(3,5-dimethyl-4-hydroxyphenyl)propane,

bis(3,5-dimethyl-4-hydroxyphenyl)sulfone,

2,4-bis(3,5-dimethyl-4-hydroxyphenyl)-2-methylbutane,

1,1-bis(3,5-dimethyl-4-hydroxyphenyl)-p-diisopropylbenzene,

1,1-bis(4-hydroxyphenyl)cyclohexane [CAS No. 843-55-0] and

alpha,alpha′-bis(4-hydroxyphenyl)-3,3,5-trimethylcyclohexane.

Particularly preferred diphenols are

2,2-bis(4-hydroxyphenyl)propane (bisphenol A),

2,2-bis(3,5-dimethyl-4-hydroxyphenyl)propane,

1,1-bis(4-hydroxyphenyl)cyclohexane [CAS No. 843-55-0],

1,1-bis(4-hydroxyphenyl)-3,3,5-trimethylcyclohexane and

dimethylbisphenol A.

These and further suitable diphenols are described for example in U.S. Pat. Nos. 3,028,635, 2,999,825, 3,148,172, 2,991,273, 3,271,367, 4,982,014 and 2,999,846, in DE-A 1 570 703, DE-A 2063 050, DE-A 2 036 052, DE-A 2 211 956 and DE-A 3 832 396, in FR-A 1 561 518, in the monograph H. Schnell, Chemistry and Physics of Polycarbonates, Interscience Publishers, New York 1964 and also in JP-A 620391986, JP-A 620401986 and JP-A 1055501986.

In the case of homopolycarbonates only one diphenol is employed and in the case of copolycarbonates two or more diphenols are employed.

Carbonic acid derivatives which are preferred to be used according to the invention are phosgene or diphenyl carbonate. Preferred chain terminators employable in the production of the polycarbonates are monophenols. Preferred monophenols are phenol, alkylphenols, especially cresols, p-tert-butylphenol, cumylphenol and mixtures thereof.

Preferred chain terminators are the phenols which are mono- or polysubstituted with linear or branched, substituted or unsubstituted C₁-C₃₀-alkyl radicals, preferably unsubstituted, or are substituted with tert-butyl. Particularly preferred chain terminators are phenyl, cumylphenol and/or p-tert-butylphenol. The amount of chain terminator to be employed is preferably in the range from 0.1 to 5 mol% based on the moles of diphenol employed in each case. The additon of the chain terminators may be carried out before, during or after the reaction with a carbonic acid derivative.

Branching agents which are preferred to be used according to the invention are the trifunctional or more than trifunctional compounds known in polycarbonate chemistry, in particular those having three or more than three phenolic OH groups.

Preferred branching agents are

1,3,5-tri(4-hydroxyphenyl)benzene,

1,1,1-tri-(4-hydroxyphenyl)ethane,

tri(4-hydroxyphenyl)phenylmethane,

2,4-bis(4-hydroxyphenylisopropyl)phenol,

2,6-bis(2-hydroxy-5′-methyl-benzyl)-4-methylphenol,

2-(4-hydroxyphenyl)-2-(2,4-dihydroxyphenyl)propane,

tetra(4-hydroxyphenyl) methane,

tetra(4-(4-hydroxyphenylisopropyl)phenoxy)methane,

1,4-bis((4′,4-dihydroxytriphenyl)methyl)benzene or

3,3-bis(3-methyl-4-hydroxyphenyl)-2-oxo-2,3-dihydroindole.

The amount of the branching agents optionally to be used is preferably in the range from 0.05 mol% to 3.00 mol% based on moles of diphenol employed in each case. The branching agents may either be initially charged in the aqueously alkaline phase with the diphenols and the chain terminators or added before the phosgenation dissolved in an organic solvent. In the case of the transesterification process the branching agents are employed together with the diphenols.

Particularly preferred polycarbonates are the homopolycarbonate based on bisphenol A, the homopolycarbonate based on 1,3-bis-(4-hydroxyphenyI)-3,3,5-trimethylcyclohexane and the copolycarbonates based on the two monomers bisphenol A and 1,1-bis(4-hydroxyphenyl)-3,3,5-trimethylcyclohexane.

Furthermore, copolycarbonates may also be used. To produce these copolycarbonates 1% to 25% by weight, preferably 2.5% to 25% by weight, particularly preferably 2.5% to 10% by weight, based on the total amount of diphenol to be employed, of polydiorganosiloxanes having hydroxyaryloxy end groups may be employed. These are known (U.S. Pat. Nos. 3,419,634, 3,189,662, EP-A 0 122 535, U.S. Pat. No. 5,227,449) and producible by processes known from the literature. Polydiorganosiloxane-containing copolycarbonates are likewise suitable and the production of the polydiorganosiloxane-containing copolycarbonates is described in DE-A 3 334 782 for example.

The polycarbonates may be present alone or as a mixture of polycarbonates. It is also possible to employ the polycarbonate or the mixture of polycarbonates together with one or more plastics distinct from polycarbonate as blend partners.

Preferably employed blend partners are polyester, in particular polybutylene terephthalate and polyethylene terephthalate, polylactide, polyether, thermoplastic polyurethane, polyacetal, fluoropolymer, in particular polyvinylidene fluoride, polyethersulfones, polyolefin, in particular polyethylene and polypropylene, polyimide, polyacrylate, in particular poly(methyl) methacrylate, polyphenylene oxide, polyphenylene sulfide, polyether ketone, polyaryl ether ketone, styrene polymers, in particular polystyrene, styrene copolymers, in particular styrene acrylonitrile copolymer, acrylonitrile butadiene styrene block copolymers or polyvinyl chloride.

One embodiment preferably contains up to 10.0% by weight, preferably 0.10 to 8.0% by weight, particularly preferably 0.2 to 3.0% by weight—based on 100% by weight of the polycarbonate to be employed as the matrix—of other customary additives.

The group of additives optionally to be used comprises flame retardants, anti-drip agents, heat stabilizers, demoulding agents, antioxidants, UV absorbers, IR absorbers, antistats, optical brighteners, light scattering agents, colourants such as pigments, including inorganic pigments, carbon black and/or dyes and inorganic fillers in the amounts customary for polycarbonate. These additives may be added individually or else in admixture.

Such additives, as are typically added to polycarbonates are described for example in EP-A 0 839 623, WO-A 96/15102, EP-A 0 500 496 or in Plastics Additives Handbook, Hans Zweifel, 5th Edition 2000, Hanser Verlag, Munich.

Fibre Composite Material

A multilayer composite material in the context of the present invention comprises at least three superposed fibre composite material plies.

Fibre composite material according to the invention is to be understood as meaning a material containing endless fibres which are embedded in a plastic matrix. In a preferred embodiment of the invention the multilayer composite material comprises at least three superposed and face-to-face joined fibre composite material plies.

The fibre composite material plies according to the invention of the multilayer composite material comprise endless fibres which have any desired alignment and are embedded in a plastic, preferably a thermoplastic, in particular a polycarbonate-based plastic, in the respective ply. These endless fibres in particular extend substantially over the entire length of the ply of a fibre composite material ply to be employed according to the invention.

In a particular embodiment of the invention all fibre composite material plies of the multilayer composite material according to the invention are face-to-face joined, wherein the endless fibres in a respective fibre composite material ply have any desired alignment and are embedded in a plastic, preferably a thermoplastic, in particular a polycarbonate-based plastic.

Further material plies may optionally be arranged between the fibre composite material plies. In a preferred embodiment the multilayer composite material according to the invention may contain not only the fibre composite material plies but also at least one further material ply between the fibre composite material plies.

Such further material plies are preferably made of plastic identical or different to the plastic in the fibre composite material plies. These further material plies made of plastic may in particular also contain fillers distinct from the endless fibres to be employed in the fibre composite material plies according to the invention. Such further material plies are preferably adhesive layers, woven fabric plies or nonwoven fabric plies. These further material plies may preferably be employed between inner fibre composite material plies, between inner fibre composite material plies and outer fibre composite material plies or between two or more inner fibre composite material plies.

In one embodiment these further material plies, preferably in the form of surface decoration plies, veneers, facings or paint layers, may in addition or alternatively be employed on one side or on both sides of outer fibre composite material plies.

In one embodiment of the present invention at least one further material ply is applied to only one outer fibre composite material ply. Such further material plies are preferably fibre composite material plies, plastic plies or paint layers which are distinct from the inner and outer fibre composite material plies and contain no unidirectionally aligned endless fibres. In one embodiment such further material plies are not fibre composite material plies, plastic plies or paint layers based on polycarbonate either.

However, it is preferable when the outer fibre composite material plies and the at least one inner fibre composite material ply are joined to one another such that no alternative material plies are arranged therebetween.

Practical experiments in the context of the present invention have shown that a multilayer composite material according to the invention exhibits advantageous mechanical properties and metallic haptics and optics even without such further, interposed material plies.

In a particularly preferred embodiment all fibre composite material plies of a multilayer composite material according to the invention contain unidirectionally aligned endless fibres embedded in a polycarbonate-based plastic.

In a preferred embodiment the multilayer composite material according to the invention may also consist exclusively of fibre composite material plies comprising endless fibres to be employed according to the invention, wherein the endless fibres in the respective fibre composite material ply have any desired alignment and are embedded in a polycarbonate-based plastic. In a further preferred embodiment such a multilayer composite material according to the invention further comprises on one or both of the outer fibre composite material plies one or more surface decoration plies, preferably in the form of at least one facing, at least one veneer or at least one paint layer.

In the context of the present invention it has proven advantageous when the multilayer composite material according to the invention comprises preferably one to eight, particularly preferably one to seven, particularly preferably one to six, inner fibre composite material plies. However, the multilayer composite material according to the invention may also comprise no inner fibre composite material plies or more than twelve, in particular thirteen, fourteen, fifteen or more than sixteen, inner fibre composite material plies.

The individual fibre composite material plies may have a substantially identical or different construction and/or orientation provided that centrosymmetry over the thickness of the multilayer composite material is overall retained. Centrosymmetry is understood by those skilled in the art to mean the presence of a plane of symmetry parallel to the individual fibre composite material plies which in cross section is precisely in the centre of the overall construction of the multilayer composite material according to the invention, i.e. where the upper half of the overall construction is a reflection of the lower half or vice versa.

In the context of the invention a substantially identical construction of the fibre composite material plies is to be understood as meaning that at least one feature from the group of chemical composition, fibre volume content and layer thickness is identical.

Chemical composition is to be understood as meaning the chemical composition of the plastic matrix of the fibre composite material and/or the chemical composition of the matrix in which the endless fibres are embedded.

In a preferred embodiment of the invention the outer fibre composite material plies have a substantially identical construction in respect of their chemical composition, their fibre volume content and their layer thickness.

According to the invention the outer fibre composite material ply is to be understood as meaning the fibre composite material ply outermost relative to the other fibre composite material plies of the multilayer composite material in each case. The endless fibres in an outer fibre composite material ply are preferably unidirectionally aligned. The endless fibres of an outer fibre composite material ply are preferably embedded in polycarbonate-based plastic.

Inner fibre composite material plies in the context of the invention are thus all fibre composite material plies arranged between the two outer fibre composite material plies.

Any desired orientation in the context of the invention means that the main directions of the endless fibres in a fibre composite material ply diverge or may diverge from the production direction of the employed textile semifinished product, especially in the direction of the warp thread in woven fabrics, in the plane in the range from >0° to <90°. Unidirectional in the context of the present invention is to be understood as meaning essentially that a divergence of the fibre running direction with respect to the two-dimensional plane (length·width) of up to 5% is possible. However, it is preferable according to the invention when the divergence of the fibre running direction is below 3%, particularly preferably below 1%.

Endless fibres which are preferred to be used according to the invention are glass fibres, carbon fibres, basalt fibres, aramid fibres, liquid crystal polymer fibres, polyphenylene sulfide fibres, polyether ketone fibres, polyether ether ketone fibres, polyetherimide fibres and mixtures thereof. The use of glass fibres and/or carbon fibres, in particular of glass fibres, has proven particularly preferable.

In a particularly preferred embodiment of the invention the endless fibres employed in the outer fibre composite material plies are carbon fibres.

For certain preferred embodiments of the invention endless fibres, in particular glass-based endless fibres having an elastic modulus of more than 60 GPa, preferably more than 65 GPa, particularly preferably of 70 GPa or more, are employed. Such endless fibres are commercially available for example from Johns Manville under the designation Multistar®. Practical experiments have shown that these glass fibres feature a particularly good weavability, i.e. processability in production processes for textile semifinished products, and are thus suitable for processing into a fibre composite material ply according to the invention.

For certain preferred embodiments of the invention endless fibres, in particular carbon-based endless fibres having an elastic modulus of more than 220 GPa, preferably more than 225 GPa, particularly preferably of 230 GPa or more, are employed. Such carbon-based endless fibres are commercially available for example from Toray Carbon Fiber Europe under the designation Torayca®. Practical experiments have shown that these carbon fibres feature a particularly good weavability, i.e. processability in production processes for textile semifinished products, and are thus suitable for processing into a fibre composite material ply according to the invention.

In a particular embodiment of the invention the at least three fibre composite material plies are arranged substantially symmetrically in the multilayer fibre composite material according to the invention. In the case of this particular embodiment the two outer fibre composite material plies have a substantially identical construction in respect of at least one feature from the group of chemical composition, fibre volume content or layer thickness.

Symmetrical in the context of the invention means essentially that the fibre composite material plies of the multilayer composite material have a substantially identical construction in respect of at least one feature, preferably all features, from the group of chemical composition, fibre volume content and layer thickness with respect to a mirror plane running parallel to the fibre composite material plies along the halfway point of the thickness of the multilayer composite material externally delimited by the two outer fibre composite material plies.

In a preferred embodiment of the invention the at least three fibre composite material plies are arranged symmetrically, wherein the two outer fibre composite material plies have a substantially identical construction in respect of all features from the group of chemical composition, fibre volume content and layer thickness.

In a further particularly preferred embodiment of the invention the at least three fibre composite material plies are arranged symmetrically, wherein the two outer fibre composite material plies have an identical construction in respect of all features from the group of chemical composition, fibre volume content and layer thickness.

In a preferred embodiment of the invention a multilayer composite material according to the invention has a total thickness in the range from 0.3 to 5 mm, preferably in the range from 0.3 to 3 mm, especially in the range from 0.3 to 2.5 mm. Practical experiments have shown that the multilayer composite material according to the invention makes it possible to achieve very good mechanical properties even at these low thicknesses.

It has proven particularly advantageous when the sum of all inner fibre composite material plies has a total thickness in the range from 0.05 to 4.6 mm, preferably in the range from 0.1 to 2.6 mm, particularly preferably in the range from 0.4 to 1.2 mm.

It is further advantageous in the context of the invention when the thickness of each of the two outer fibre composite material plies is in each case in the range from 0.02 to 1 mm, preferably in the range from 0.1 to 0.5 mm, particularly preferably in the range from 0.15 to 0.3 mm

In respect of the mechanical properties it has been found in the context of the invention that, surprisingly, particularly good results are achieved when the multilayer composite material according to the invention has a thickness ratio of the sum of the two outer fibre composite material plies to the sum of all inner fibre composite material plies of 1 to 2.5.

It has been found that, surprisingly, a polycarbonate-based multilayer composite material having this abovementioned thickness ratio of the sum of the two outer fibre composite material plies to the sum of all inner fibre composite material plies has markedly improved mechanical properties compared to a polycarbonate-based multilayer composite material not having this thickness ratio. It is thus especially possible with the abovementioned thickness ratio to obtain polycarbonate-based multilayer composite materials which in measurements according to the method described in the experimental part, both at 0° and 90°, exhibit flexural elastic moduli which are sufficient for further use as a housing part for electronic devices and especially diverge from one another by less than 5%.

In a particular embodiment of the invention a fibre composite material ply has a fibre volume content in the range from 30% by volume to 80% by volume, preferably in the range from 35% by volume to 65% by volume, particularly preferably in the range from 37% by volume to 52% by volume. Tests in the context of the present invention have shown that at a fibre volume content of less than 30% by volume the mechanical properties of the resulting fibre composite material under a point load are often suboptimal, i.e. the fibre composite material cannot adequately withstand a point load and in some cases can even be pierced. The tests in the context of the present invention have further shown that a fibre volume content of more than 80% by volume likewise resulted in a deterioration in the mechanical properties of the fibre composite material. At such high fibre volume content the fibres are presumably no longer adequately wetted during impregnation, thus leading to an increase in air inclusions and to increased occurrence of surface defects in the multilayer composite material.

In one embodiment of the invention the outer fibre composite material plies preferably have a fibre volume content of at most 60% by volume, particularly preferably of at most 55% by volume, especially preferably of at most 51% by volume.

In one embodiment of the invention the outer fibre composite material plies preferably have a fibre volume content of at least 30% by volume, particularly preferably of at least 35% by volume, especially preferably of at least 37% by volume.

The inner fibre composite material plies preferably have a fibre volume content in the range from 30% by volume to 80% by volume, particularly preferably in the range from 35% by volume to 65% by volume, particularly preferably in the range from 37% by volume to 52% by volume, based on the total volume of the fibre composite material plies.

In the context of the present invention vol% is to be understood as meaning the volume fraction (% v/v) based on the total volume of the respective fibre composite material ply.

It has proven particularly practical when the inner fibre composite material plies have an identical orientation and their orientation relative to the outer fibre composite material plies is rotated by 0° . However, it is also conceivable to rotate the inner fibre composite material plies relative to the outer fibre composite material plies by 30°, 40°, 50°, 60°, 70° or 90°. The orientation may in any case diverge from the recited guide values by ±5°, preferably by ±3°, particularly preferably by ±1°.

The fibre composite material plies of a multilayer composite material according to the invention may be produced with the customary processes for producing fibre composite materials known to those skilled in the art.

Particularly good results in respect of the mechanical properties and surface smoothness are established when the following production process is employed: In a preferred embodiment of the invention the fibre composite material plies of the multilayer composite material are producible by applying a plastic, preferably a thermoplastic, in particular a polycarbonate-based plastic, onto an endless fibre tape or textile under application of pressure and temperature. Such a production process is described in EP 0131879 A1 or EP 0212232 A2.

It has been found that, surprisingly, the thus produced fibre composite material plies feature a particularly low proportion of air inclusions and very good mechanical properties despite the use of stress-cracking-prone plastics, in particular polycarbonate. The multilayer composite material according to the invention obtainable from the thus produced fibre composite material plies exhibits not only metallic haptics and optics but also very good mechanical properties, in particular in respect of point loads.

The at least three fibre composite material plies of the multilayer composite material according to the invention preferably comprises substantially no voids, in particular substantially no air inclusions.

In one embodiment substantially no voids means that the void content of the at least three fibre composite material plies of the multilayer composite material according to the invention is below 2% by volume, in particular below 1% by volume, particularly preferably below 0.5% by volume.

In the context of the present invention determination of the void content of a fibre composite material ply or of the multilayer composite material was carried out according to the thickness difference method. This comprises determining the layer thickness difference between a theoretical component thickness and the actual component thickness for known basis weights and densities of the plastic and the fibre. When calculating the theoretical component thicknesses it is assumed that the fibre composite material construction contains no voids and complete wetting of the fibres with polymer is achieved. Relating the thickness difference to the actual component thickness affords the percentage void content. Measurement of the thicknesses may preferably be carried out with an outside micrometer. For this method, error-minimized results may preferably be determined by determining the void content on components composed of a plurality of fibre composite material plies, preferably more than 4 fibre composite material plies, particularly preferably more than 6 fibre composite material plies and very particularly preferably more than 8 fibre composite material plies.

It is very particularly preferable when the at least three fibre composite material plies of a multilayer composite material according to the invention comprise no voids, in particular no air inclusions.

Preference according to the invention is therefore given to multilayer composite materials comprising
3 to 25 fibre composite material plies, preferably 3 to 20 fibre composite material plies, particularly preferably 3 to 18 fibre composite material plies,
wherein the fibre composite material plies each have a basis weight in the range from 5 g/m² to 3000 g/m², preferably in the range from 100 g/m² to 900 g/m², particularly preferably in the range from 150 g/m² to 750 g/m²,
and the entirety of all fibre composite material plies is impregnated with at least one plastic, preferably polycarbonate, having an MVR according to ISO 1133 in the range from 1 cm³/10 min to 100 cm³/10 min,
and the outer fibre composite material plies have a fibre volume content to be determined according to DIN 1310 of at most 60% by volume, preferably of at most 55% by volume, in particular of at most 51% by volume,
and the outer fibre composite material plies have a fibre volume content to be determined according to DIN 1310 of at least 30% by volume, preferably of at least 35% by volume, especially preferably of at least 37% by volume,
and the inner fibre composite material plies have a fibre volume content to be determined according to DIN 1310 of <80% by volume, preferably <65% by volume, particularly preferably <52% by volume, based on the total volume of the inner fibre composite material plies,
and the inner fibre composite material plies have a fibre volume content to be determined according to DIN 1310 of >30% by volume, preferably >35% by volume, particularly preferably of >37% by volume, based on the total volume of the inner fibre composite material plies,
and the multilayer composite material has a void proportion of less than 2% by volume, preferably less than 1% by volume, especially preferably less than 0.5% by volume,
   and the endless fibres are in the form of a textile semifinished product, preferably in the form of a balanced woven fabric, a nonwoven fabric or a fibre mat, wherein the endless fibres in the respective fibre composite material ply have any desired orientation,
   with the proviso that
a) in the case of an inner fibre composite material ply said ply is rotated by 0° to 90° with respect to the two outer fibre composite material plies,
b) for ≥2 inner fibre composite material plies these inner fibre composite material plies have a substantially identical orientation and their orientation with respect to the outer fibre composite material plies is rotated by 0° to 90°,
   and the orientation of a fibre composite material ply is defined by the orientation of the textile semifinished product containing the endless fibres, the thermoplastic employed is at least one from the group consisting of polycarbonates, polybutylene terephthalates, styrene-acrylonitriles, polystyrenes, polyether ether ketones, polyetherimides, polysulfones, thermoplastic elastomers, polyphenylene sulfides and mixtures thereof, in particular polycarbonate, and any desired orientation is to be understood as meaning a divergence of the main directions of the endless fibres in a fibre composite material ply from the production direction of the employed textile semifinished product in the plane in the range from >0° to <90°.

Particular preference according to the invention is given to multilayer composite materials in which in addition the sum of all inner fibre composite material plies has a total thickness in the range from 0.05 to 4.6 mm, preferably in the range from 0.1 to 2.6 mm, particularly preferably in the range from 0.4 to 1.8 mm.

Very particular preference according to the invention is given to multilayer composite materials in which in addition the thickness of each of the two outer fibre composite material plies is in each case 0.02 to 1 mm, preferably in each case 0.1 to 0.5 mm, particularly preferably in each case 0.15 to 0.3 mm.

Process for Producing a Fibre Composite Material Ply

The preferred process for producing a fibre composite material ply of the thermoplastic-based multilayer fibre composite material according to the invention in particular comprises the following steps of:
(i) providing a textile semifinished product and conveying this textile semifinished product along a processing path,
(ii) applying the plastic, preferably the polycarbonate-based plastic, over the entire width of the textile semifinished product on one surface of this textile semifinished product,
(iii) combining the required number of plastic-treated textile semifinished products in superposed form and simultaneously conveying along a common processing path,
(iv) applying a pressure to the superposed, plastic-treated textile semifinished products perpendicular to the plane of the textile semifinished products, wherein the application of pressure with at least one compression ram coupled with simultaneous temperature-elevation of the compression ram with a longitudinal motion component in the belt plane and perpendicular to a textile semifinished product ply running direction is carried out using a static heated press, preferably using a heatable interval heating press or heatable double-belt press, particularly preferably using a heatable double-belt press,
(v) simultaneously holding the multi-ply construction of the plastic-treated textile semifinished product plies in a processing temperature range above the glass transition temperature of the plastic to be employed, and
(vi) reducing the processing temperature range, preferably before the application of pressure is terminated.

The use of interval heating presses, also occasionally known as interval hot presses, in the production of composites is known to those skilled in the art from EP 3257893 A1. Double-belt presses are known to those skilled in the art from EP 0131879 A1.

Polymer application of plastic, preferably of polycarbonate-based plastic, with subsequent application of pressure/temperature results in effective incorporation of the plastic melt into the entire fibre volume structure of the textile semifinished product provided that the pressure is combined with a temperature above the glass transition temperature of the employed plastic.

The temperature during application of pressure, based on the glass transition temperature of the plastic, is preferably in the range from +50° C. to +300° C., particularly preferably in the range from +80° C. to +200° C., very particularly preferably in the range from +120° C. to +180° C., especially preferably +150° C.

The temperature during application of pressure with polycarbonate-based plastic is preferably in the range from +50° C. to +300° C., particularly preferably in the range from +80° C. to +200° C., very particularly preferably in the range from +120° C. to +180° C., especially preferably +150° C.

When reference is made here to heating to above the glass transition temperature of the plastic or holding above the glass transition temperature of the plastic this is to be understood as meaning heating to a temperature at which the plastic is completely molten. In the context of the present invention the glass transition temperature or glass transition temperature of the plastic is determined according to DIN EN ISO 17025.

The longitudinal motion during the application of pressure/temperature ensures that any gas volumes still present in the textile semifinished products are efficiently expelled. The process is preferably performed continuously. The holding of the multi-ply construction at a temperature above the polymer-specific glass transition temperature of the plastic, preferably the polycarbonate-based plastic, ensures that the plastic does not undergo undesired solidification in and on the textile semifinished product before complete penetration. After performing the recited process steps the produced, impregnated multi-ply construction is cooled in a defined fashion. The textile semifinished product may comprise a multiplicity of endless fibres. The application of pressure/temperature makes it possible to ensure only limited, if any, damage to the fibres coupled with good plastic penetration of the textile semifinished product, i.e. coupled with good impregnation.

The process for producing a fibre composite material ply of a multilayer composite material according to the invention is particularly preferably run such that the application of the plastic, preferably of the polycarbonate-based plastic, to the textile semifinished product is carried out while the textile semifinished product is conveyed under standard atmospheric pressure. Such an application of the plastic avoids complex and inconvenient external sealing of a pressurized application chamber.

The pressure during the application of pressure/temperature is preferably in the range from 0.01 MPa to 3 MPa.

Process for Producing a Multilayer Fibre Composite Material

According to the invention, the combining of the layered fibre composite material plies to afford the multilayer composite material is to be understood as meaning any process which results in a physical joining of the layered fibre composite material plies.

The present invention therefore also relates to a process for producing a multilayer composite material comprising the following steps of:
(I) providing at least one inner fibre composite material ply and two outer fibre composite material plies,
(II) placing the at least one inner fibre composite material ply between the outer fibre composite material plies,
(III) joining the layered fibre composite material plies, in particular using pressure and/or temperature, by means of at least one static heated press, preferably a heatable interval heating press or heatable double-belt press, particularly preferably using a heatable double-belt press,
   with the proviso that each of these at least three inner and outer fibre composite material plies contains endless fibres in the form of a textile semifinished product, preferably in the form of a balanced woven fabric, a nonwoven fabric or a fibre mat, wherein the endless fibres in the respective fibre composite material ply have any desired alignment and are embedded in thermoplastic, preferably polycarbonate-based plastic, wherein

a) in the case of an inner fibre composite material ply said ply is rotated by 0° to 90° with respect to the two outer fibre composite material plies,

b) for ≥2 inner fibre composite material plies these inner fibre composite material plies have a substantially identical orientation and their orientation with respect to the outer fibre composite material plies is rotated by 0° to 90°,

and the orientation of a fibre composite material ply is defined by the orientation of the textile semifinished product containing the endless fibres.

In a preferred embodiment the combining of the layered fibre composite material plies results in face-to-face joined fibre composite material plies. Face-to-face joined means that at least 50%, preferably at least 75%, or preferably at least 90%, or preferably at least 95%, or preferably at least 99%, or 100% (“full face-to-face” join), of the surfaces of two adjacent fibre composite material plies that are facing one another are directly joined to one another. The degree of joining may be determined in cross-sections by microscopy or else determined by the absence of voids, in particular air inclusions, in the fibre composite material.

The process according to the invention preferably affords quasi-isotropic multilayer composite materials having an elastic modulus combination of greater than 30 GPa in the 0° direction and of greater than 30 GPa in the 90° direction, i.e. virtually isotropic and thus metallic material characteristics. It is particularly preferable when a multilayer composite material according to the invention has an elastic modulus combination of greater than 35 GPa in the 0° direction and of greater than 35 GPa in the 90° direction.

Process for Producing a Multilayer Composite Material Housing

Producing a housing, in particular a housing for electrical or electronic devices, comprises performing the following steps of:

(i) providing a multilayer composite material according to the invention as the starting material,

(ii) forming and/or assembling with further components to afford the housing part.

The invention therefore also relates to a process for producing a housing, in particular a housing for electrical or electronic devices, by
(i) providing at least one multilayer composite material (1), comprising at least three superposed fibre composite material plies (2) and (3) defined relative to one another as two outer fibre composite material plies (3) and at least one inner fibre composite material ply (2), wherein
   each of these at least three fibre composite material plies (2) and (3) contains endless fibres (4) in the form of a textile semifinished product, wherein the endless fibres (4) in the respective fibre composite material ply (2) or (3) have any desired orientation and are embedded in thermoplastic (5),
      with the proviso that
      a) the at least one inner fibre composite material ply (2) is rotated by 0° to 90° with respect to the outer fibre composite material plies (3),
      b) for inner fibre composite material plies (2) these inner fibre composite material plies have a substantially identical orientation and their orientation with respect to the outer fibre composite material plies (3) is rotated by 0° to 90°,
      wherein the orientation of a fibre composite material ply (2) or (3) is defined by the orientation of the textile semifinished product containing the endless fibres,
      the thermoplastic employed is at least one from the group consisting of polycarbonates, polybutylene terephthalates, styrene-acrylonitriles, polystyrenes, polyether ether ketones, polyetherimides, polysulf ones, thermoplastic elastomers, polyphenylene sulfides and mixtures thereof, in particular polycarbonate, and any desired orientation is to be understood as meaning a divergence of the main directions of the endless fibres in a fibre composite material ply from the production direction of the employed textile semifinished product in the plane in the range from >0° to <90°, and
(ii) forming and/or assembling with further components.

Preference is given to a process in which the textile semifinished product is a balanced woven fabric, a nonwoven fabric or a fibre mat.

Preference is given to a process in which the thickness ratio of the sum of the two outer fibre composite material plies (3) to the sum of all inner fibre composite material plies (2) is in the range from 0.25 to 5.

Preference is given to a process in which the fibre composite material plies (2) and (3) are obtainable by applying the molten thermoplastic to a raw textile preheated to above the glass transition temperature of the plastic to be employed.

Preference is given to a process in which the fibre volume content of the outer fibre composite material plies (3) is at most 60% by volume based on the volume of the outer fibre composite material plies (3).

Preference is given to a process in which the at least three fibre composite material plies (2) and (3) are arranged substantially symmetrically, wherein the two outer fibre composite material plies (3) have a substantially identical construction in respect of at least one feature from the group of chemical composition, fibre volume content and layer thickness.

Preference is given to a process in which the multilayer composite material (1) has a total thickness of 0.3 to 2.5 mm.

Preference is given to a process in which the multilayer composite material (1) comprises one to eight inner fibre composite material plies (2).

Preference is given to a process in which the at least three fibre composite material plies (2) and (3) comprise substantially no voids, in particular substantially no air inclusions.

Preference is given to a process in which the endless fibres (4) are selected from the group consisting of glass fibres, carbon fibres, basalt fibres, aramid fibres, liquid crystal polymer fibres, polyphenylene sulfide fibres, polyether ketone fibres, polyether ether ketone fibres, polyetherimide fibres and mixtures thereof, in particular glass fibres and/or carbon fibres.

Preferred housings are housings or housing parts for the back side of a mobile telephone, for the underside of a laptop, for the monitor back side of a laptop monitor, for the back side of a tablet etc. or else only a constituent of a back side of a mobile telephone, an underside of a laptop, a monitor back side of a laptop monitor, a back side of a tablet etc. It is preferable when the multilayer composite material housing according to the invention is the monitor back side (so-called “a-cover”) or the underside (so-called “d-cover”) of a laptop or a constituent of the monitor back side or the underside of a laptop.

The invention therefore preferably relates to an electronic device or housing part containing at least one multilayer composite material according to the invention. It is preferable when the electronic device is a monitor, a tablet, a laptop, a mobile telephone or a computer, in particular a laptop. The housing of an electronic device is preferably the monitor back side (a) or the underside (d) of a laptop.

A further advantage of the multilayer composite material according to the invention is that it may be subjected to forming to afford any desired shapes. Forming may be carried out using all forming processes known to those skilled in the art. Such forming processes may be carried out under the action of pressure and/or temperature.

In one embodiment of the process according to the invention the forming is carried out under the action of temperature, in particular through thermoforming.

The invention further provides a housing part suitable for use as or for use in a housing of an electronic device, wherein the housing part contains a multilayer composite material according to the invention or is obtainable by the process for producing a housing part according to the invention and wherein the housing of an electronic device is preferably the monitor back side or the underside of a laptop.

The present invention further provides an electronic device, in particular a computer, monitor, tablet or telephone, containing a multilayer composite material according to the invention or obtainable by a process for producing a housing part, wherein the computer is preferably a laptop.

In order to be used as the housing of an electronic device or in a housing of an electronic device the multilayer composite material according to the invention should be able to withstand a point load such as is generated for example when an electronic device is dropped or is unitentionally trodden on. The multilayer composite materials according to the invention not only have a surprisingly metallic appearance, metallic sound and metallic haptics but are also particularly well resistant to point loads. This makes them particularly suitable for use in portable IT housings in particular.

It has been found that, surprisingly, a multilayer composite material according to the invention having an elastic modulus combination of greater than 30 GPa in the 0° direction and of greater than 30 GPa in the 90° direction, i.e. virtually isotropic and thus metallic material characteristics, meets the point loadability requirements demanded of a housing of an electronic device particularly well. A multilayer composite material according to the invention preferably has an elastic modulus combination of greater than 35 GPa in the 0° direction and of greater than 35 GPa in the 90° direction. As is illustrated in the exemplary embodiments this selection rule may be observed especially by adjustment of the relative layer thicknesses in the multilayer composite material and/or of the fibre volume contents.

The invention therefore also relates to the use of multilayer composite materials (1) according to the invention for producing housings, in particular housings for electrical or electronic devices, by
(i) providing at least one multilayer composite material (1), comprising at least three superposed fibre composite material plies (2) and (3) defined relative to one another as two outer fibre composite material plies (3) and at least one inner fibre composite material ply (2), wherein
   each of these at least three fibre composite material plies (2) and (3) contains endless fibres (4) in the form of a textile semifinished product, wherein the endless fibres (4) in the respective fibre composite material ply (2) or (3) have any desired orientation and are embedded in thermoplastic (5),
      with the proviso that
      a) the at least one inner fibre composite material ply (2) is rotated by 0° to 90° with respect to the outer fibre composite material plies (3),
      b) for ≥2 inner fibre composite material plies (2) these inner fibre composite material plies have a substantially identical orientation and their orientation with respect to the outer fibre composite material plies (3) is rotated by 0° to 90°,
      wherein the orientation of a fibre composite material ply (2) or (3) is defined by the orientation of the textile semifinished product containing the endless fibres,
   the thermoplastic employed is at least one from the group consisting of polycarbonates, polybutylene terephthalates, styrene-acrylonitriles, polystyrenes, polyether ether ketones, polyetherimides, polysulfones, thermoplastic elastomers, polyphenylene sulfides and mixtures thereof, in particular polycarbonate, and any desired orientation is to be understood as meaning a divergence of the main directions of the endless fibres in a fibre composite material ply from the production direction of the employed textile semifinished product in the plane in the range from >0° to <90°, and
(ii) forming and/or assembling with further components.

Preference is given to a use in which the textile semifinished product is a balanced woven fabric, a nonwoven fabric or a fibre mat.

Preference is given to a use in which the thickness ratio of the sum of the two outer fibre composite material plies (3) to the sum of all inner fibre composite material plies (2) is in the range from 0.25 to 5.

Preference is given to a use in which the fibre composite material plies (2) and (3) are obtainable by applying the molten thermoplastic to a raw textile preheated to above the glass transition temperature of the plastic to be employed.

Preference is given to a use in which the fibre volume content of the outer fibre composite material plies (3) is at most 60% by volume based on the volume of the outer fibre composite material plies (3).

Preference is given to a use in which the at least three fibre composite material plies (2) and (3) are arranged substantially symmetrically, wherein the two outer fibre composite material plies (3) have a substantially identical construction in respect of at least one feature from the group of chemical composition, fibre volume content and layer thickness.

Preference is given to a use in which the multilayer composite material (1) has a total thickness of 0.3 to 2.5 mm.

Preference is given to a use in which the multilayer composite material (1) comprises one to eight inner fibre composite material plies (2).

Preference is given to a use in which the at least three fibre composite material plies (2) and (3) comprise substantially no voids, in particular substantially no air inclusions.

Preference is given to a use in which the endless fibres (4) are selected from the group consisting of glass fibres, carbon fibres, basalt fibres, aramid fibres, liquid crystal polymer fibres, polyphenylene sulfide fibres, polyether ketone fibres, polyether ether ketone fibres, polyetherimide fibres and mixtures thereof, in particular glass fibres and/or carbon fibres.

The invention also relates to a fibre composite material ply comprising unidirectionally aligned endless fibres embedded in a polycarbonate-based plastic. The polycarbonate-based plastic is preferably a linear polycarbonate and the unidirectionally aligned endless fibres preferably have an elastic modulus of greater than 220 GPa. Practical experiments on polycarbonate have shown that such fibre composite material plies are particularly well amenable to further processing into multilayer composite materials according to the invention having very good quasi-isotropic stiffness.

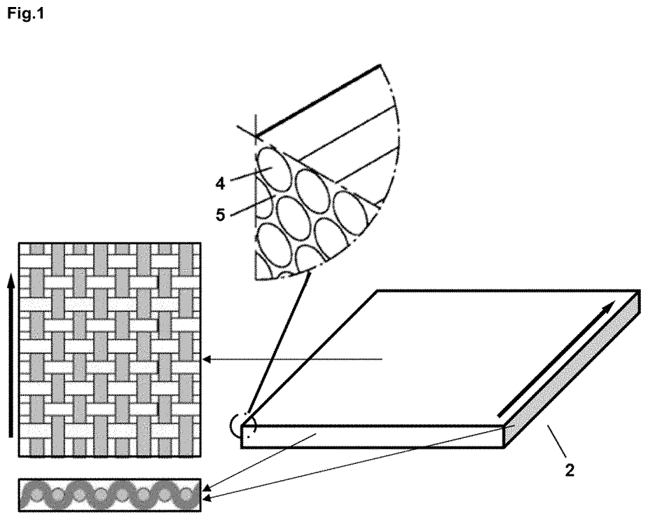

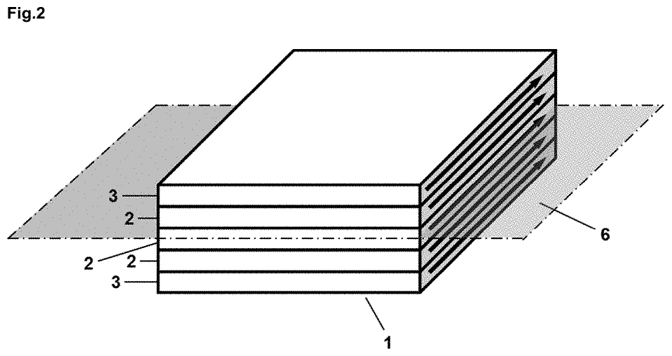

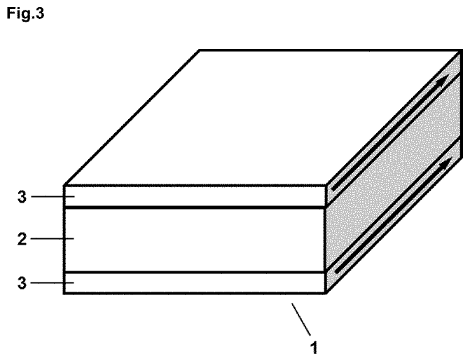

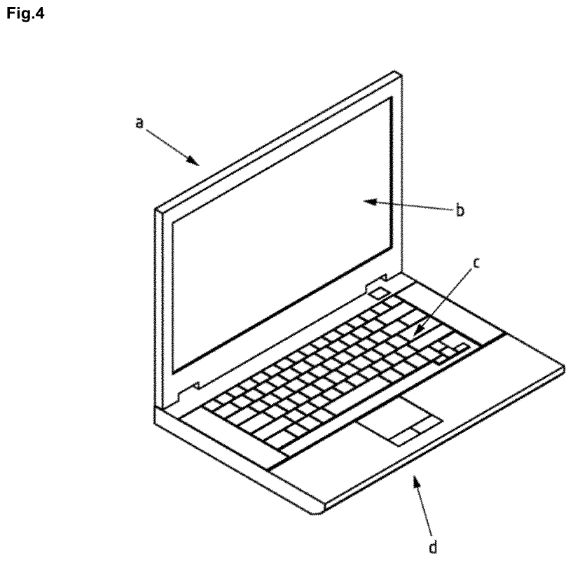

Further details and advantages of the invention are apparent from FIG. 1, FIG. 2, FIG. 3 and FIG. 4 and the descriptions of these preferred embodiments.

FIG. 1 shows a fibre composite material ply (2) with woven fabric reinforcement in schematic and perspective view with enlarged sections of the visible surfaces. The textile semifinished product based on a balanced woven fabric and employed for a fibre composite material ply according to FIG. 1 has a linen weave in which 50% of the endless fibres have a 0° orientation and 50% of the endless fibres have a 90° orientation. The enlarged section in FIG. 1 shows that the reinforcing fibres of the fibre composite material ply are in the form of a textile semifinished product based on endless fibres (4) which are unidirectionally aligned in two directions within the ply, wherein the endless fibres (4) are in the form of a balanced woven fabric having a linen weave and are embedded in a plastic (5), preferably a polycarbonate-based plastic. The orientation of the fibre composite material ply is determined by the orientation of the unidirectionally aligned endless fibres present therein. The main direction, i.e. the production direction, of the textile semifinished product, here in the form of a balanced woven fabric, is shown with an arrow in FIG. 1. The endless fibres extend over the total length/width of the fibre composite material ply.

FIG. 2 shows a multilayer composite material (1) according to the invention in schematic and perspective view composed of five superposed fibre composite material plies in centosymmetric arrangement, wherein the three inner fibre composite material plies (2) have an identical orientation and their orientation relative to the two outer fibre composite material plies (3) is rotated by 0°. In the multilayer composite material (1) according to FIG. 2 all five superposed fibre composite material plies thus have an identical orientation as indicated by arrows. The fibre composite material plies (2) and (3) are joined with a full face-to-face join. The fibre composite material plies may differ in their construction, for example in respect of fibre proportion, fibre material, fabric weave. In FIG. 2 the ply construction of the multilayer composite material (1) is mirrored in the symmetry plane (6).

FIG. 3 shows a multilayer composite material (1) in schematic and perspective view composed of three superposed fibre composite material plies (3), (2), (3), wherein the inner fibre composite material ply (2) has a different thickness to the two outer fibre composite material plies (3). The two outer fibre composite material plies (2) have an identical orientation. The fibre reinforcement of the inner fibre composite material ply (2) may be in the form of any desired textile. The construction is automatically centrosymmetric on account of the three-ply construction.

FIG. 4 shows a laptop in schematic and perspective view. The housing part of the laptop forming the monitor back side (a) of the monitor (b) is also referred to in the art as the “a-cover”. The housing part of the laptop forming the underside (d) of the keyboard (c) is typically referred to as the “d-cover”. The monitor back side (a) and the underside (d) of the laptop contain a multilayer composite material according to the invention.

It will be understood that the specification and examples are illustrative but not limitative of the present invention and that other embodiments within the spirit and scope of the invention will suggest themselves to those skilled in the art.

### EXAMPLES

1. Description of Raw Materials and Test Methods

Component A

Linear polycarbonate based on bisphenol A having a melt volume flow rate MVR of 14.0 CM³/10 min (as per ISO 1133 at a test temperature of 240° C. and 1.2 kg loading).

Component B

Carbon fibre Torayca® T300 from Toray Carbon Fiber Europe having a single filament diameter of 7, a density of 1.76 g/cm³ and a tensile modulus of 230 GPa. This is supplied with 3000 individual filaments in a fibre bundle (roving) as a woven fabric having a twill weave and a basis weight of 200 g/m².

Methods of Measurement:

The methods for determining the relevant parameters recited hereinbelow were used for performing/evaluating the examples and are also the methods for determining the parameters relevant according to the invention in general.

Determination of Thickness and Thickness Ratio

Thickness determination of the fibre composite material plies and the multilayer composite materials that result after joining was carried out with a commercially available outside micrometer. The result reported was the arithmetic mean of 5 individual measurements at different positions.

The thickness ratio of the two outer fibre composite material plies to the sum of the inner fibre composite material plies may firstly be carried out in the course of production by determining the individual thicknesses of the fibre composite material plies before joining of the fibre composite material plies to afford the multilayer composite material. The practical experiments showed that in the commonly used processes for joining the fibre composite material plies, in particular laminating under the action of pressure and temperature, the ratio of the thicknesses to one another remains substantially unchanged even upon compression and thus aggregate reduction in the thicknesses. The thickness ratios described here relate to the individual thicknesses of the fibre composite material plies determined in the course of production before the joining of the fibre composite material plies to afford the multilayer composite material.

Alternatively, the determination of the thickness ratio may also be carried out in the finished multilayer composite material. This is achieved by examination of a cross section of the material by microscopy. The change in orientation of the fibre running direction upon transition from the inner to the two outer fibre composite material plies makes these fibre composite material plies readily identifiable by microscopy. For layer thickness determination a plane running parallel to the planes defined by the fibre running direction halfway between the last endless fibre belonging to the outer fibre composite material ply and the first endless fibre belonging to the inner fibre composite material ply is used as the layer boundary.

Void Content Determination

The void content was determined by means of the thickness difference method as described above on the test specimens previously joined by means of an interval heating press. Determination of the actual sample thickness was carried out at 5 points of measurement distributed over the component to be analysed. Calculation of the void content used the arithmetic mean of the 5 individual determinations of the actual sample thickness.

Flexural Elastic Modulus

To determine the flexural elastic modulus, 5 test specimens per orientation (0°, 90°) were first prepared from the produced multilayer composite material sheets with a Mutronic Diadisc 5200 cutting saw using CFK fine diamond cutting discs. An outside micrometer was then used to determine the exact specimen dimensions relevant for the tests (width and thickness). The test was performed analogously to DIN ISO 14125. Deviations from this standard relate to the test specimen thickness which on account of the number of fibre composite plies in the multilayer construction is ply-specific and unchangeable and therefore may diverge from the specimen thickness specified in the standard. The slope of the resulting force-distance diagram corresponds to the flexural elastic modulus. The result determined and reported here is the arithmetic mean of the 5 individual measurements.

Determination of Fibre Volume Content

In the present process the textile semifinished product based on fibres of the component B was passed at a constant wetting rate through the plastic melt based on the component A. The fibre volume content of a fibre composite material ply is thus calculated from the difference in the melt volume flow of the plastic melt and the product of the production rate of the fibre composite material ply and the cross section of the fibre composite material ply to be produced.

2. Production and Results

Production of the Fibre Composite Material Plies

Production of the fibre composite material ply from the above-described components A and B was carried out according to the process described in EP 0 131 879 A1. The textile based on a woven fabric having a basis weight of 200g/m² and a twill weave was treated with component A on both sides of the raw textile plane. Once application of pressure/temperature was complete the following compositions of the fibre composite material plies were obtained as an organosheet:

TABLE 1
Overview of properties of the individual composite material plies

| Composite | Content of | Content of | Layer |
|---|---|---|---|
| material | component A in | component B in | thickness in |
| ply | [% by volume] | [% by volume] | [μm] |
| 1 | 55 | 45 | 250 |

Production of the Multilayer Composite Materials

Specific layup of the fibre composite material plies in the following orientations afforded multilayer composite material test specimens which were used for further characterization.

TABLE 2
Overview of type, orientation and number of employed fibre composite
material plies in the multilayer composite materials

| | Inner plies | | | Outer plies | | |
|---|---|---|---|---|---|---|
| | Composite | | | Composite | | |
| Test | material | Orien- | Total | material | Orien- | Total |
| specimen | ply | tation | number | ply | tation | number |
| M | 1 | 0° | 6 | 1 | 0° | 2 |

After layup, the test specimens were semicontinuously joined to one another in an interval heating press. The applied surface pressure was 25 bar. The temperature in the heating zone was 280° C. and the temperature in the cooling zone was 100° C. Furthermore, the advancement per cycle was 30 mm and the cycle time was 10 seconds. The thicknesses of the individual textile specimens were retained after joining to a test specimen therein.

Results of Flexural Elastic Modulus Determination and Determination of Void Content

TABLE 3
Flexural elastic moduli in 0° and 90° orientation of multilayer
composite materials having different ply construction

| | Flexural elastic | Flexural elastic | | Void |
|---|---|---|---|---|
| | modulus in 90° | modulus in 0° | Test specimen | content |
| Test | orientation in | orientation in | thickness in | in |
| specimen | [GPa] | [GPa] | [μm] | [%] |
| M | 46.4 | 47.6 | 1.927 | 0% |

The tests show that an inventive polycarbonate-based multilayer composite material M exhibited an identical flexural elastic modulus both at 90° orientation and at 0° orientation which is additionally comparable to the flexural elastic modulus of metallic materials (for example magnesium: 44 GPa, independent of sample orientation). Results shown for example in WO 2017/072053 A1 in each case exhibit flexural elastic moduli at 90° orientation that are at most only 67%, and in some cases only 15%, of the corresponding value in the 0° direction and thus differ markedly from the properties of metallic materials. The values determined for an inventive multilayer composite material based on plastic of the component A and textile semifinished product of the component B ensure that the inventive specimens withstand a multiaxial load resulting for instance when, for example, a component, in particular a housing, to be produced therefrom is dropped or subjected to an unintentional surface load. It is further apparent that the content of voids was minimized by the production process and was below 0.5% for all samples analysed.

What is claimed is:

1. A multilayer composite material (1), comprising at least three superposed fiber composite material plies defined relative to one another as two outer fibre composite material plies (3) and at least one inner fiber composite material ply (2), wherein
each of these at least three fiber composite material plies (2) and (3) contains endless fibers (4) in the form of a textile semifinished product, wherein the endless fibers (4) in the respective fiber composite material ply (2) or (3) have any desired orientation and are embedded in thermoplastic (5),
wherein
a) the at least one inner fiber composite material ply (2) is rotated by 0° to 90° with respect to the outer fibre composite material plies (3), and
b) when there are two or more inner fiber composite material plies (2) present these inner fiber composite material plies have a substantially identical orientation to one another and their orientation with respect to the outer fiber composite material plies (3) is rotated by 0° to 90°, and
where the orientation of a fiber composite material ply (2) or (3) is defined by the orientation of the textile semifinished product containing the endless fibers and having any desired orientation is a divergence of the main directions of the endless fibers in a fiber composite material ply from the production direction of the employed textile semifinished product in the plane in the range from >0° to <90°.

2. A multilayer composite material (1) according to claim 1, wherein the textile semifinished product is a balanced woven fabric, a nonwoven fabric or a fiber mat.

3. A multilayer composite material (1) according to claim 1, wherein the thermoplastic (5) is selected from the group consisting of polycarbonates, polybutylene terephthalates, styrene-acrylonitriles, polystyrenes, polyether ether ketones, polyetherimides, polysulfones, thermoplastic elastomers, polyphenylene sulfides and mixtures thereof.

4. A multilayer composite material (1) according to claim 1, wherein the thermoplastic (5) is polycarbonate.

5. A multilayer composite material (1) according to claim 1, wherein the thickness ratio of the sum of the two outer fibre composite material plies (3) to the sum of all inner fibre composite material plies (2) is in the range from 0.25 to 5.

6. A multilayer composite material (1) according to claim 1, wherein the fiber composite material plies (2) and (3) are obtainable by applying a molten thermoplastic to a raw textile preheated to above the glass transition temperature of the plastic to be employed.

7. A multilayer composite material (1) according to claim 1, wherein the fiber volume content of the outer fiber composite material plies (3) is at most 60% by volume based on the volume of the outer fiber composite material plies (3).

8. A multilayer composite material (1) according to claim 1, wherein the at least three fiber composite material plies (2) and (3) are arranged substantially symmetrically and wherein the two outer fiber composite material plies (3) have a substantially identical construction in respect of at least one feature from the group of chemical composition, fiber volume content and layer thickness.

9. A multilayer composite material (1) according to claim 1, wherein the multilayer composite material (1) has a total thickness of 0.3 to 2.5 mm.

10. A multilayer composite material (1) according to claim 1, wherein the multilayer composite material (1) comprises one to eight inner fiber composite material plies (2).

11. A multilayer composite material (1) according to claim 1, wherein the at least three fiber composite material plies (2) and (3) comprise no voids.

12. A multilayer composite material (1) according to claim 11, wherein the voids are air inclusions.

13. A multilayer composite material (1) according to claim 1, wherein the endless fibers (4) are selected from the group consisting of glass fibers, carbon fibers, basalt fibers, aramid fibers, liquid crystal polymer fibers, polyphenylene sulfide fibers, polyether ketone fibers, polyether ether ketone fibers, polyetherimide fibers and mixtures thereof.

14. A multilayer composite material (1) according to claim 1, wherein the endless fibers (4) are selected from glass fibers and/or carbon fibers.

15. The process for producing a multilayer composite material according to claim 1, comprising the following steps of:
providing the at least one inner fiber composite material ply (2) and two outer fiber composite material plies (3),
placing the at least one inner fiber composite material ply (2) between the outer fiber composite material plies (3) and
joining the layered fiber composite material plies (2) and (3) therey forming the multilayer composite material (1).

16. The process according to claim 15, wherein pressure and temperature are used when joining the layered fiber composite material plies (2) and (3).

17. The process according to to claim 15, wherein the textile semifinished product is a balanced woven fabric, a nonwoven fabric or a fiber mat.

18. The process according to claim 15, wherein the thickness ratio of the sum of the two outer fibre composite material plies (3) to the sum of all inner fibre composite material plies (2) is in the range from 0.25 to 5.

19. The process according to claim 15, wherein the fiber composite material plies (2) and (3) are obtainable by applying a molten thermoplastic to a raw textile preheated to above the glass transition temperature of the plastic to be employed.

20. The process according to claim 15, wherein the fiber volume content of the outer fiber composite material plies (3) is at most 60% by volume based on the volume of the outer fiber composite material plies (3).
